(19) United States
(12) Patent Application Publication
(10) Pub. No.: US 2026/0078849 A1
(43) Pub. Date: Mar. 19, 2026

(54) JOINT STRUCTURE AND FLUID CONTROL DEVICE

(71) Applicant: FUJIKIN INCORPORATED, Osaka (JP)

(72) Inventors: Taiki HOSHIKO, Osaka (JP); Kazunari WATANABE, Osaka (JP)

(21) Appl. No.: 19/401,691

(22) Filed: Nov. 26, 2025

Related U.S. Application Data
(63) Continuation of application No. PCT/JP2024/014049, filed on Apr. 5, 2024.

(30) Foreign Application Priority Data
May 29, 2023 (JP) 2023-087977

(51) Int. Cl. F16L 23/032

(52) U.S. Cl. CPC F16L 23/032

(57) ABSTRACT

A joint structure the joint structure includes: a flange formed with a first bolt screw hole and a second bolt screw hole located between a first bolt screw hole and a second bolt screw hole formed in the flange; a first sleeve and a second sleeve, each having an interior serving as a fluid passage in communication with a fluid passage of a flow passage block, the first sleeve and second sleeve being inserted into the first sleeve insertion hole and the second sleeve insertion hole of the flange, respectively; and a first bolt and a second bolt that are screwed into the first bolt screw hole and the second bolt screw hole of the flange through a first bolt insertion hole and a second bolt insertion hole formed in the flow passage block, thereby fixing the flange to the same surface of the flow passage block.

### CROSS REFERENCE TO RELATED APPLICATION

This application is a continuation application under 35 U.S. C. § 120 of No. PCT/JP2024/014049, filed Apr. 5, 2024, which is incorporated herein by reference, and which claims priority to Japanese Application No. 2023-087977, filed May 29, 2023. The present application likewise claims priority under 35 U.S. C. § 119 to Japanese Application No. 2023-087977, filed May 29, 2023, the entire content of which is also incorporated herein by reference.

### TECHNICAL FIELD

The present disclosure relates to a joint structure used in fluid control devices employed in semiconductor manufacturing equipment and the like, and to a fluid control device including the joint structure.

### BACKGROUND

A semiconductor manufacturing equipment including a gas unit for supplying gas to a processing chamber is known. The gas unit is configured with a plurality of fluid control devices and numerous pipes connecting the plurality of fluid control devices to each other. Each fluid control device has a flow passage block in which a fluid passage is formed, with the flow passage opening at the lower surface of the flow passage block. The pipes are connected to the flow passage of the flow passage block via a flanged pipe joint. The flanged pipe joint is composed of one flange and one sleeve, wherein the flange is connected to the flow passage block by two bolts from the lower side, and the pipe is configured to be connected to the sleeve.

### SUMMARY

When a plurality of flow passages is formed in the flow passage block and a plurality of flow passages open at the lower surface, it is necessary to connect the flange and the sleeve to each flow passage using two bolts from the lower side. However, in the gas unit, the space below the flow passage block is extremely limited, resulting in poor workability for pipe connection to the flow passage block.

Therefore, the present disclosure is to provide a joint structure and a fluid control device capable of easily connecting pipes to a flow passage block in which a plurality of fluid passages is formed.

A joint structure according to one embodiment of the present disclosure is a joint structure for connecting pipes to a flow passage block having a plurality of fluid passages opening on a same surface. The joint structure includes: a flange formed with a first bolt screw hole and a second bolt screw hole, and a first sleeve insertion hole and a second sleeve insertion hole, the first sleeve insertion hole and the second sleeve insertion hole being located between the first bolt screw hole and the second bolt screw hole; a first sleeve and a second sleeve, each having an interior serving as a fluid passage in communication with a fluid passage of the flow passage block, the first sleeve and second sleeve being connected to the pipes and inserted into the first sleeve insertion hole and the second sleeve insertion hole of the flange, respectively; and a first bolt and a second bolt that are screwed into the first bolt screw hole and the second bolt screw hole of the flange through a first bolt insertion hole and a second bolt insertion hole formed in the flow passage block, thereby fixing the flange to the same surface of the flow passage block.

### BRIEF DESCRIPTION OF THE DRAWINGS

In the drawings:

FIG. 1 is a perspective view of a fluid control device and a plurality of pipes according to an embodiment;

FIG. 2 is a perspective view of a flange of a joint structure; and

FIG. 3 is a cross-sectional view of a flow passage block and the joint structure.

### DETAILED DESCRIPTION

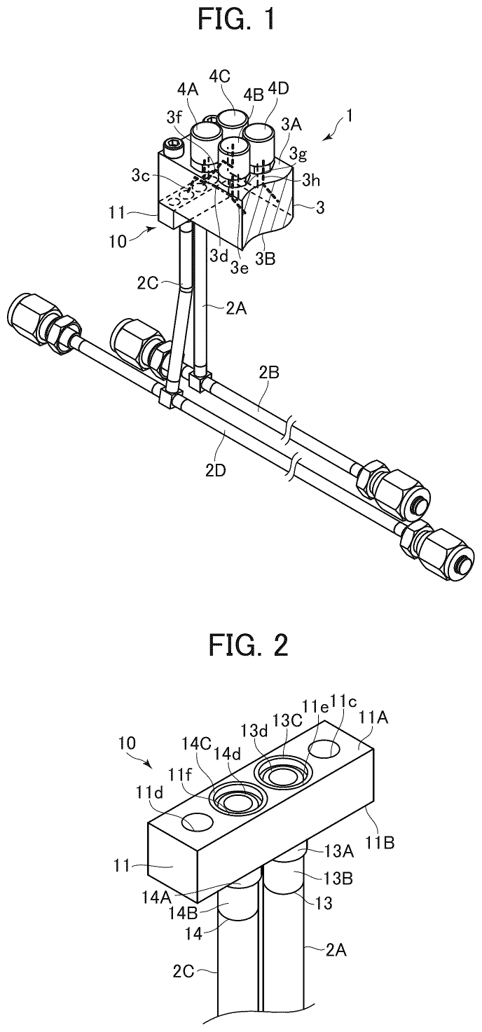

A joint structure and a fluid control device according to an embodiment of the present disclosure will be described with reference to the drawings. In the following description, “upper”and “lower”refer to the upper and lower directions as shown in FIG. 1.

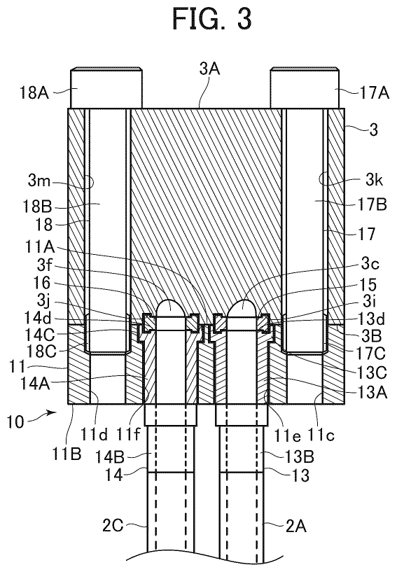

FIG. 1 is a perspective view of a fluid control device 1 and a plurality of pipes 2A to 2D according to an embodiment of the present disclosure. FIG. 2 is a perspective view of a flange 11 of a joint structure 10. FIG. 3 is a cross-sectional view of a flow passage block 3 and the joint structure 10.

As shown in FIG. 1, the fluid control device 1 includes a flow passage block 3, fluid control units 4A to 4D, and a joint structure 10. The flow passage block 3 has a substantially rectangular parallelepiped shape and includes an upper surface 3A and a lower surface 3B. The upper surface 3A is a surface located on the opposite side of the lower surface 3B. The fluid control units 4A to 4D are disposed on the upper surface 3A of the flow passage block 3. The interiors of the fluid control units 4A to 4D are in communication with first to sixth fluid passages 3c to 3h, which will be described later. The fluid control units 4A to 4D are, for example, valves, actuators, or the like.

The flow passage block 3 has first to sixth fluid passages 3c to 3h formed therein. The first fluid passage 3c has one end opening at the lower surface 3B and the other end opening at a portion of the upper surface 3A where the fluid control unit 4A is located. The second fluid passage 3d has one end opening at a portion of the upper surface 3A where the fluid control unit 4A is located and the other end opening at a portion of the upper surface 3A where the fluid control unit 4B is located. The third fluid passage 3e has one end opening at a portion of the upper surface 3A where the fluid control unit 4B is located, and the other end, not shown, opening at the lower surface 3B. The fourth fluid passage 3f has one end opening at the lower surface 3B and the other end opening at a portion of the upper surface 3A where the fluid control unit 4C is located. The fifth fluid passage 3g has one end opening at a portion of the upper surface 3A where the fluid control unit 4C is located and the other end opening at a portion of the upper surface 3A where the fluid control unit 4D is located. The sixth fluid passage 3h has one end opening at a portion of the upper surface 3A where the fluid control unit 4D is located and the other end, not shown, opening at the lower surface 3B.

As shown in FIG. 3, on the lower surface 3B of the flow passage block 3, an annular first recess 3i is formed around the opening of the first fluid passage 3c and an annular second recess 3j is formed around the opening of the fourth fluid passage 3f. At both ends of one side of the flow passage block 3 along its longitudinal direction, first and second bolt insertion holes 3k and 3m are formed, penetrating from the upper surface 3A to the lower surface 3B.

As shown in FIG. 2 and FIG. 3, the joint structure 10 includes a flange 11, first and second sleeves 13 and 14, first and second gaskets 15 and 16, and first and second bolts 17 and 18.

The flange 11 has a substantially rectangular parallelepiped block shape and includes a contact surface 11A and a piping surface 11B. The contact surface 11A is in contact with the lower surface 3B of the flow passage block 3. The piping surface 11B is located on the opposite side of the contact surface 11A. The flange 11 is formed with a first bolt screw hole 11c, a second bolt screw hole 11d, a first sleeve insertion hole 11e, and a second sleeve insertion hole 11f. The first and second sleeve insertion holes 11e and 11f are located between the first and second bolt screw holes 11c and 11d.

The first and second bolt screw holes 11c and 11d and the first and second sleeve insertion holes 11e and 11f penetrate the flange 11 so as to open at the contact surface 11A and the piping surface 11B. Female threads are formed on the contact surface 11A side of the first and second bolt screw holes 11c and 11d. The first and second bolt screw holes 11c and 11d are counterbored holes and have a large-diameter portion on the contact surface 11A side.

The first and second sleeves 13 and 14 have a substantially cylindrical shape, with their interiors serving as fluid passages. These fluid passages are in communication with the first fluid passage 3c and the fourth fluid passage 3f of the flow passage block 3, respectively. The first and second sleeves 13 and 14 are inserted into the first and second sleeve insertion holes 11e and 11f, respectively.

The first and second sleeves 13 and 14 have large-diameter portions 13A and 14A and small-diameter portions 13B and 14B. The small-diameter portions 13B and 14B are located below the large-diameter portions 13A and 14A. Flange portions 13C and 14C are provided at the upper ends of the large-diameter portions 13A and 14A. The flange portions 13C and 14C are inserted into the counterbored portions of the first and second sleeve insertion holes 11e and 11f. Annular third and fourth recesses 13d and 14d are formed on the upper surfaces of the flange portions 13C and 14C. The lower ends of the large-diameter portions 13A and 14A protrude downward beyond the piping surface 11B of the flange 11.

The first and second gaskets 15 and 16 have an annular shape. The first gasket 15 is accommodated in the first recess 3i and the third recess 13d. The second gasket 16 is accommodated in the second recess 3j and the fourth recess 14d. The first and second gaskets 15 and 16 seal between the first and fourth fluid passages 3c and 3f, the fluid passages of the first and second sleeves 13 and 14, and the outside.

The first and second bolts 17 and 18 include heads 17A and 18A, shaft portions 17B and 18B, and male thread portions 17C and 18C. The heads 17A and 18A have hexagonal holes formed therein. The shaft portions 17B and 18B extend downward from the heads 17A and 18A and are inserted through the first and second bolt insertion holes 3k and 3m. The male thread portions 17C and 18C are provided at the lower ends of the shaft portions 17B and 18B and are screwed into the first and second bolt screw holes 11c and 11d.

As shown in FIG. 1 to FIG. 3, the fluid control device 1 is connected to first to fourth pipes 2A to 2D. The first pipe 2A extends in the vertical direction and is welded to a lower end of the first sleeve 13. The second pipe 2B is welded to a lower end of the first pipe 2A and extends in a direction orthogonal to the first pipe 2A. The third pipe 2C is welded to a lower end of the second sleeve 14. The third pipe 2C has an upper portion extending vertically, and a lower portion bent relative to the upper portion, inclining away from the first pipe 2A. The fourth pipe 2D is welded to a lower end of the third pipe 2C and extends in a direction orthogonal to the first pipe 2A. The second pipe 2B and the fourth pipe 2D are positioned substantially in the same plane.

A method for connecting the pipes 2 to the flow passage block 3 using the joint structure 10 will be described. First, the first sleeve 13 is inserted into the first sleeve insertion hole 11e of the flange 11, and the first pipe 2A is welded to the first sleeve 13. The second sleeve 14 is inserted into the second sleeve insertion hole 11f of the flange 11, and the third pipe 2C is welded to the second sleeve 14. Next, the second pipe 2B is welded to the first pipe 2A. While the first sleeve 13, the first pipe 2A, and the second pipe 2B are held up by a jig, the fourth pipe 2D is welded to the third pipe 2C. After the welding is completed, the first sleeve 13, the first pipe 2A, and the second pipe 2B are lowered. In this way, the welding of the second pipe 2B and the fourth pipe 2D is performed separately with the pipes spaced apart from each other, so that the thermal influence on the welded portions can be suppressed.

The first and second gaskets 15 and 16 are placed in the third and fourth recesses 13d and 14d of the first and second sleeves 13 and 14, and the contact surface 11A of the flange 11 is brought close to the lower surface 3B of the flow passage block 3. In this state, the first and second bolts 17 and 18 are inserted from the upper surface 3A side of the flow passage block 3 into the first and second bolt insertion holes 3k and 3m and screwed into the first and second bolt screw holes 11c and 11d of the flange 11, thereby compressing the first and second gaskets 15 and 16. As a result, the flange 11 is fixed to the lower surface 3B of the flow passage block 3, and the pipes 2A to 2D are connected to the flow passage block 3 via the joint structure 10.

According to the joint structure 10 of the present embodiment, two first and second sleeves 13 and 14 can be easily connected to a flow passage block 3 having a plurality of fluid passages formed therein using one flange 11 and two first and second bolts 17 and 18. In other words, according to the joint structure 10, the pipes 2A to 2D can be easily connected to the flow passage block 3 having a plurality of fluid passages formed therein. Additionally, compared to conventional joint structures, the joint structure 10 of the present embodiment does not require working space below the lower surface 3B of the fluid control device 1, which also facilitates the installation of other pipes, fluid control devices or the like. Furthermore, compared to conventional joint structures, the joint structure 10 of the present embodiment can reduce the number of components, thereby achieving cost reduction.

Additionally, the first and second bolts 17 and 18 are inserted into the first and second bolt insertion holes 3k and 3m from the upper surface 3A side of the flow passage block 3 and screwed into the first and second bolt screw holes 11c and 11d of the flange 11, thereby fixing the flange 11 to the lower surface 3B of the flow passage block 3. Therefore, the fixing of the flange 11 to the flow passage block 3 can be performed from the upper surface 3A side, improving the workability of assembly.

The present disclosure is not limited to the embodiment described above. Those skilled in the art can make various additions or modifications within the scope of the present disclosure.

In the above embodiment, the flange 11 has two first and second sleeve insertion holes 11e and 11f formed between the first bolt screw hole 11c and the second bolt screw hole 11d, but three or more sleeve insertion holes may be formed, with sleeves inserted into each sleeve insertion hole. The flow passage block 3 is not limited to the above embodiment, and the shape of the flow passage block, the shape of the fluid passages, and the positions of the openings may be modified according to the number, function, and position of the fluid control units.

What is claimed is:

1. A joint structure for connecting pipes to a flow passage block having a plurality of fluid passages opening on a same surface, the joint structure comprising:
a flange formed with a first bolt screw hole and a second bolt screw hole, and a first sleeve insertion hole and a second sleeve insertion hole, the first sleeve insertion hole and the second sleeve insertion hole being located between the first bolt screw hole and the second bolt screw hole;
a first sleeve and a second sleeve, each having an interior serving as a fluid passage in communication with a fluid passage of the flow passage block, the first sleeve and second sleeve being connected to the pipes and inserted into the first sleeve insertion hole and the second sleeve insertion hole of the flange, respectively; and
a first bolt and a second bolt that are screwed into the first bolt screw hole and the second bolt screw hole of the flange through a first bolt insertion hole and a second bolt insertion hole formed in the flow passage block, thereby fixing the flange to the same surface of the flow passage block.

2. A fluid control device comprising:
a flow passage block having a plurality of fluid passages opening on the same surface;
a flange formed with a first bolt screw hole and a second bolt screw hole, and a first sleeve insertion hole and a second sleeve insertion hole, the first sleeve insertion hole and the second sleeve insertion hole being located between the first bolt screw hole and the second bolt screw hole, the flange being in contact with the same surface;
a first sleeve and a second sleeve, each having an interior serving as a fluid passage in communication with a fluid passage of the flow passage block, the first sleeve and second sleeve being connected to pipes and inserted into the first sleeve insertion hole and the second sleeve insertion hole of the flange, respectively; and
a first bolt and a second bolt that are screwed into the first bolt screw hole and the second bolt screw hole of the flange through a first bolt insertion hole and a second bolt insertion hole formed in the flow passage block, thereby fixing the flange to the same surface of the flow passage block.
